(19) United States
(12) Patent Application Publication
(10) Pub. No.: US 2002/0194344 A1
(43) Pub. Date: Dec. 19, 2002

(54) Network connection establishing method and telephone therefor

(75) Inventor: Youichiro Nishikawa, Osaka (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Sanyo Electric Co., Ltd.

(21) Appl. No.: 10/012,243

(22) Filed: Nov. 6, 2001

(30) Foreign Application Priority Data
Nov. 6, 2000 (JP) 2000-338034

(51) Int. Cl. G06F 15/16

(52) U.S. Cl. 709/227

(57) ABSTRACT

An originator terminal notifies an originator number via a telephone network, calls a receiver terminal, then disconnects a line and gets connected to the Internet. The receiver terminal searches originator information based on the originator number, and gets connected to the Internet. An IP address assigned then is notified to the originator terminal, and the originator terminal sends a connection request to the IP address thus notified. The receiver terminal sends a connection establishing response to an IP address of the originator terminal, and gets connected to the Internet with the arrival of a call transmitted via the telephone line as a trigger.

### BACKGROUND OF THE INVENTION

1. Field of the Invention

The present invention relates to a connection technology via a network. This invention particularly relates to a method of connecting an originator's device and a receiver's device via the network, and a telephone device which can utilize the method.

2. Description of the Related Art

The Internet has become widespread, and an environment in which the Internet can be utilized in many homes is being prepared. Along with it, the telephone service using the Internet (hereinafter referred to simply as an “Internet phone” also) is beginning to be utilized.

The telephone service using ordinary telephone networks has a problem of high charges for telephone calls when one calls the other party far away. In contrast thereto, the charges for Internet phone calls include only the charge for a call from an originator's telephone device to the Internet service provider nearest to him/her and the charge for a call from a receiver's telephone device to the Internet service provider nearest to him/her and in addition the charges to be paid to the Internet service providers and for the Internet phone service. In recent years the charges to be paid to Internet service providers have declined considerably, and as a result there are now some cases where one can place an Internet phone call cheaper than through the ordinary telephone.

However, it cannot be said yet that the environment in which the connection to the Internet is constantly possible is wide spread, and a receiver is not necessarily connected to the Internet when one places an Internet phone call to the receiver.

On the Internet, communication is made using an IP address that specifies one's own device. With the devices which are always connected to the Internet, the IP addresses given to them are fixed, so that both parties use their IP addresses in place of their ordinary telephone numbers and can inform each other of the IP addresses in advance. In an environment where there is no constant connection to the Internet, however, an IP address is given after a dial-up connection to the Internet service provider is established, and therefore it is not always the case that the same IP address is given.

Thus, the use of the Internet phone has always involved a possibility that inconvenient circumstances arise without an environment where the constant connection to the Internet is possible. There has been a demand for a technology that allows the use of the Internet phone by utilizing the currently widespread infrastructure without requiring the constant-connection-possible environment.

### SUMMARY OF THE INVENTION

The present invention has been made in view of the foregoing circumstances and an object thereof is to provide a technology which connects an originator's device and a receiver's device via a network.

Another object of the present invention lies in providing methods to facilitate its connection and realize the cost merits.

An aspect of the present invention relates to a connection method. This method is to connect an originator device and a receiver device via a network, and the method includes: notifying, by the originator device via a second network which differs from the network, the receiver device of originator information which specifies the originator device; establishing a connection to the network by the originator device and the receiver device; acquiring, by the receiver device, a receiver address which specifies the receiver device in the network; acquiring, by the originator device, an originator address which specifies the originator device in the network; notifying, by the receiver device, a device specified by the originator information of the receiver address; notifying, by the originator device, a device specified by the receiver address of the originator address, and requesting a connection via the network; and responding to the device specified by the originator address so as to establish the connection via the network, by the receiver device. It is to be noted that the network, when referred to simply as a “network”, means a targeted network which is not the second network.

As an example of the network there is the Internet. When the Internet is used as a network, IP addresses may be used as the originator address and the receiver address. As an example of the second network there is a telephone network. When the telephone network is used as the second network, the telephone number assigned to an originator device may be used as an example of originator information.

According to this method, a receiver device connects to the network, using a signal communicated from an originator device via the second network as a trigger, so that a connection via the network can be established even when the receiver terminal is not connected to the network.

Where the Internet is used as a network, the IP address assigned to one's own device is not fixed when a connection to the Internet is made by a dial-up to an Internet service provider as is normally done. Thus, the IP address of the own device is notified to a destination device in order to realize communication via the Internet.

Another aspect of the present invention relates also to a connection method. In this method, an originator informs his/her own address. This method includes: requesting, by an originator device, a through-the-network connection to a receiver device via a second network which differs from the network; establishing connections to the network, by the originator device and the receiver device; acquiring, by the receiver device, a receiver address which specifies the receiver device in the network; acquiring, by the originator device, an originator address which specifies the originator device in the network; notifying, by the originator device, the receiver device of the originator address; notifying, by the receiver device, a device specified by the originator address of the receiver address; and establishing a connection via the network between the originator device and the receiver device.

Still another aspect of the present invention relates to a telephone device. This telephone device comprises: a calling unit which makes a call to a telephone device of a receiver via a telephone network; a line disconnection requesting unit which requests disconnection of a line of the telephone network after the call is made; an Internet connection requesting unit which requests a connection to the Internet after notifying originator information; an own-device address receiving unit which acquires an own-device address to specify own device in the Internet; a destination-device address receiving unit which receives a receiver address sent from the telephone device of the receiver, to specify the telephone device of the receiver in the Internet; and a connection requesting unit which notifies the own-device address to the receiver address, and requests a through-the-Internet connection.

Still another aspect of the present invention relates to a telephone device. This telephone device comprises: a line monitoring unit which monitors a connection request notified from a telephone device of an originator via a telephone network; an originator information receiving unit which receives originator information, notified together with the connection request, to specify the telephone device of the originator; an Internet connection requesting unit which requests a connection to the Internet when the connection request is received; an own-device address receiving unit which acquires an own-device address to specify an own device in the Internet; an address table which stores the originator information and mail addresses to which the own-device address is to be notified, in a manner that the originator information is associated with the mail address; a notifying address search unit which acquires the mail address to be notified, by referring to said address table; an own-device address notification unit which transmits the own-device address to the mail address to be notified; a destination-device address receiving unit which receives a destination-device address, which was transmitted to the own-device address from the telephone device of the originator, to specify the telephone device of the originator in the Internet; and a connection response unit which, upon receipt of a request of a through-the-Internet connection, transmits a response to establish the connection.

The telephone device may further comprise: a calling unit which makes a call to a telephone device of a receiver via a telephone network; a line disconnection requesting unit which requests disconnection of a line of the telephone network after the call is made; a second Internet connection requesting unit which requests a connection to the Internet after notifying originator information; a second own-device address receiving unit which acquires an own-device address to specify an own device in the Internet; a second destination-device address receiving unit which receives a receiver address sent from the telephone device of the receiver, to specify the telephone device of the receiver in the Internet; and a connection requesting unit which notifies the own-device address to the receiver address, and requests the through-the-Internet connection.

This summary of the invention does not necessarily describe all necessarily features so that the invention may also be sub-combination of these described features.

### BRIEF DESCRIPTION OF THE DRAWINGS

FIG. 1 shows a structure of a telephone system according to a first embodiment.

FIG. 2 shows an outline of a connection method according to the first embodiment.

FIG. 3 illustrates how an originator terminal makes a call to a receiver terminal.

FIG. 4 illustrates how the originator terminal disconnects a line and gets connected to the Internet, and then the receiver terminal gets connected to the Internet.

FIG. 5 illustrates how the receiver terminal notifies the originator terminal of an own-device address.

FIG. 6 shows how the originator terminal sends a connection request to the receiver terminal.

FIG. 7 shows an internal structure of a telephone device according to the first embodiment.

FIG. 8 shows internal data of an address table.

FIG. 9 shows an internal structure of an Internet phone reception controller.

FIG. 10 shows an internal structure of an Internet phone transmission controller.

FIG. 11 shows an outline of a connection method according to a second embodiment.

### DETAILED DESCRIPTION OF THE INVENTION

The invention will now be described based on the preferred embodiments. This does not intend to limit the scope of the present invention, but exemplify the invention.

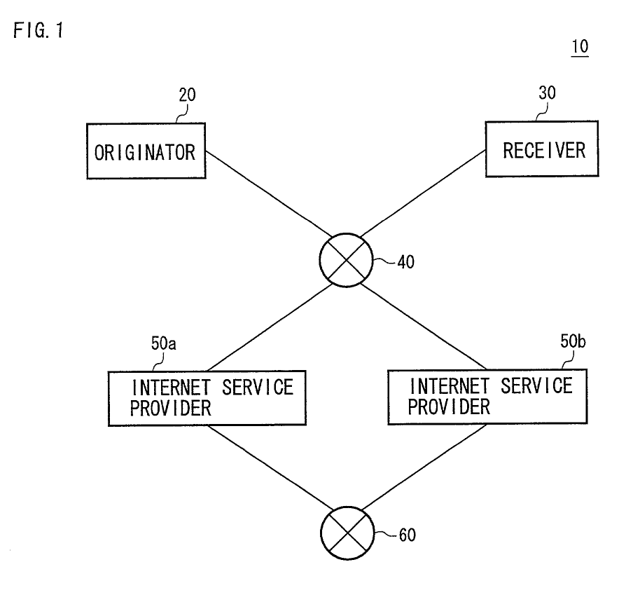

FIG. 1 shows a structure of a telephone system 10 according to a first embodiment. In the telephone system 10, an originator's terminal 20 and a receiver's terminal 30 are connected to a telephone network 40, which is an example of a second network, and are further connected to the Internet 60, which is an example of a network, via Internet service providers 50a and 50b (hereinafter referred to simply as “providers”). The originator's terminal 20 and the receiver's terminal 30, which may be, for instance, telephone devices, portable telephone devices or personal computers, are so structured as to enable transmission and reception of information containing audio via the Internet 60. They may also be so structured as to enable transmission and reception of information, such as image and moving pictures, in addition to the audio. When the originator terminal 20 or the receiver terminal 30 is a portable telephone, a connection to a telephone network is made via a portable telephone network and a connection to the Internet 60 is made via a portable telephone packet network. This, however, will not be touched on hereafter because the method according to the present embodiment can be used the same way.

The present embodiments mainly relate to a technology to be used in an environment in which a connection to the Internet is made when necessary by dialing up a provider 50 and not in an environment in which the Internet is always connected. In order to get a connection via the Internet 60 to the receiver terminal 30 which is not connected to the Internet 60, it is necessary to request a connection to the receiver terminal 30 via the second network other than the Internet 60.

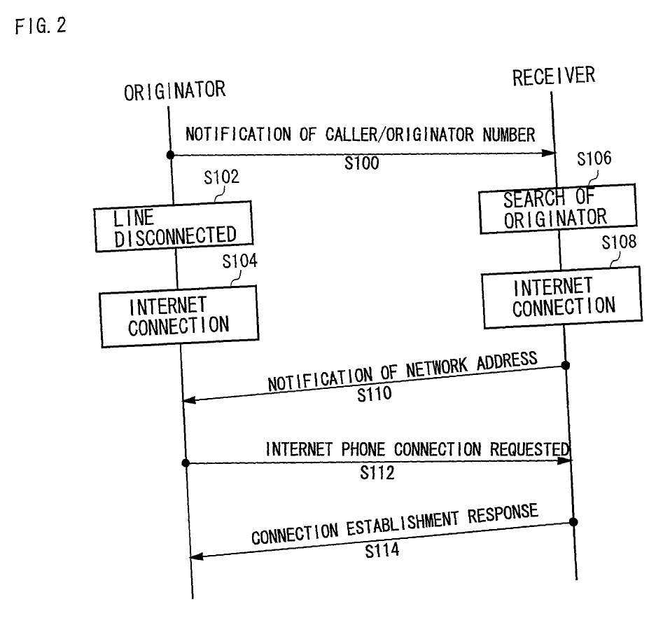

FIG. 2 outlines the procedure up to the establishment of a connection between the originator terminal 20 and the receiver terminal 30 over the Internet 60 in the telephone system 10. First the originator terminal 20 calls the receiver terminal 30 via a telephone network 40 (S100). At this time, the receiver terminal 30 is notified of the telephone number assigned to the originator terminal 20. The originator number notifying function, which is a technology widely used in today's telephone networks, can be realized without requiring any new structure in particular. Then the originator terminal 20 disconnects the line by which it has called the receiver terminal 30 (S102) and then requests a connection to the Internet by calling an access point of a provider 50a through the telephone network 40 (S104). With a connection to the Internet 60 permitted by the provider 50a, an IP (Internet Protocol) address, which is used to specify the originator terminal 20 on the Internet, is given to the originator terminal 20. Thereafter, the originator terminal 20 performs transmission and reception of information via the Internet 60, using this IP address.

On the other hand, upon arrival of a call from the originator terminal 20, the receiver terminal 30 makes a search for originator information based on an originator number notified (S106). The receiver terminal 30, which is in possession of a table storing the telephone numbers of the originators associated with the mail addresses to be used in notifying them of the IP address of the receiver's own device, makes a search of this table and acquires the mail address of a notifying party. At this point, the procedure may be terminated without carrying out the following processing if the call was placed from a telephone number not stored in the table. Or a necessary processing in response to the call may be carried out, interpreting it as a line connection request via the ordinary telephone network 40. Following this, the receiver terminal 30 requests the provider 50b to connect it to the Internet 60 (S108). Upon the permission of a connection to the Internet 60 by the provider 50b, an IP (Internet Protocol) address that identifies the receiver terminal 30 on the Internet 60 is assigned to the receiver terminal 30. Thereafter, the receiver terminal 30 carries out transmission and reception of information via the Internet 60, using this IP address.

Here, the same IP addresses are not necessarily given as the IP addresses for the originator terminal 20 and the receiver terminal 30, so that the transmission and reception of information between the originator terminal 20 and the receiver terminal 30 over the Internet 60 can not be realized unless something is done about it. It is therefore necessary that the both parties be notified of each other's IP addresses in some way.

Thus, the receiver terminal 30 notifies the IP address given to its own device, to the mail address of the notifying party obtained in S106 (S110). The originator terminal 20 receives this mail by connecting to the Internet 60 and learns the IP address of the receiver terminal 30. Then the originator terminal 20 makes a request for a connection via the Internet 60 to the IP address of the receiver terminal 30 (S112). At this time, the IP address assigned to the originator terminal 20 is notified. The receiver terminal 30 transmits a response for the establishment of a connection via the Internet 60 to the IP address of the originator terminal 20 (S114). This completes the connection via the Internet 60 of the originator terminal 20 and the receiver terminal 30. The originator and the receiver communicate with each other through the transmission and reception of information such as voice and images, and disconnect the connection upon the completion of the call.

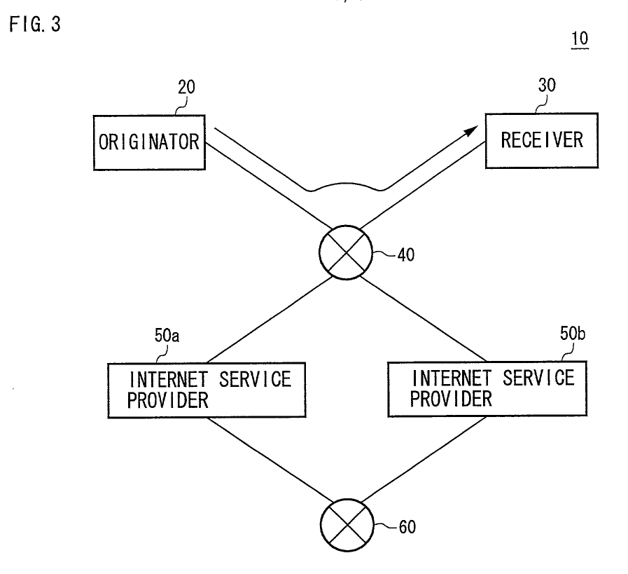

FIGS. 3 to 6 plainly illustrate the exchange shown in FIG. 2, using the system structure shown in FIG. 1. FIG. 3 shows how a call is made from the originator terminal 20 to the receiver terminal 30 (S100). At this time, the originator number is notified to the receiver terminal 30 via the telephone network 40.

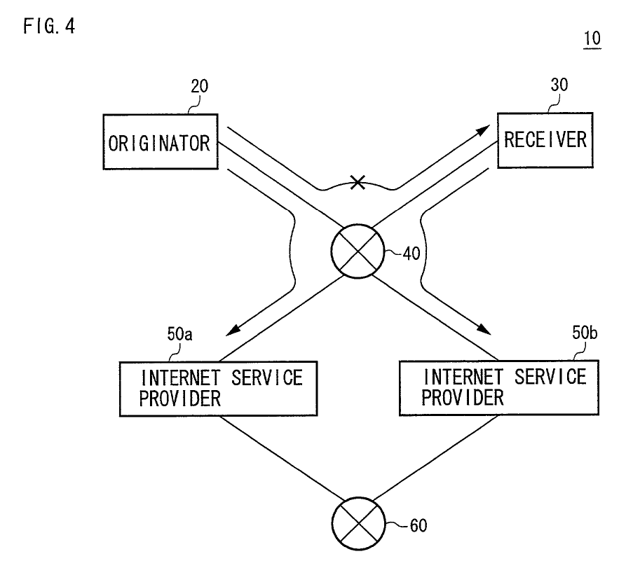

FIG. 4 illustrates how the originator terminal 20 disconnects the line once (S102) and connects to the Internet 60 (S104) and at the same time the receiver terminal 30 connects to the Internet 60 (S106). The originator terminal 20 disconnects the line by which it has called the receiver terminal 30 and again gets a dial-up connection to the provider 50a via the telephone network 40. After the originator terminal 20 disconnects the line of the telephone network 40, the receiver terminal 30 gets a dial-up connection to the provider 50b via the telephone network 40.

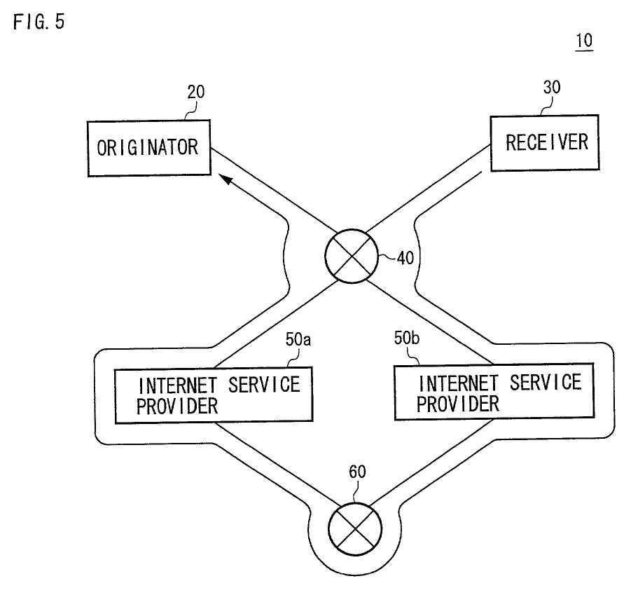

FIG. 5 illustrates how the receiver terminal 30 notifies an IP address of the own device to the originator terminal 20 (S110). After connecting to the Internet 60, the receiver terminal 30 transmits the IP address of the own device to the mail address of the originator. After connecting to the Internet 60, the originator terminal 20 receives the mail and learns the IP address of the receiver terminal 30.

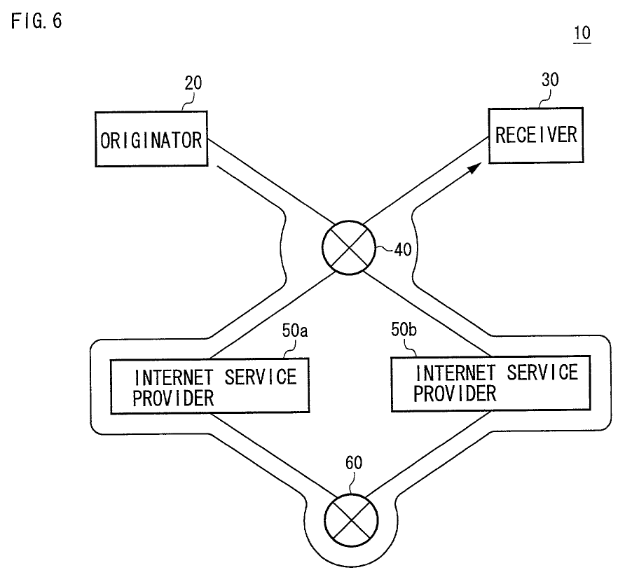

FIG. 6 illustrates how the originator terminal 20 requests a connection over the Internet 60 to the receiver terminal 30 (S112). The originator terminal 20, which has learned the IP address of the receiver terminal 30, can transmit a connection request to the IP address of the receiver terminal 30. At this time, the IP address of the originator terminal 20 is notified to the receiver terminal 30. Thereby, both parties come to know each other's IP addresses and thus transmission and reception of information via the Internet 60 can be made.

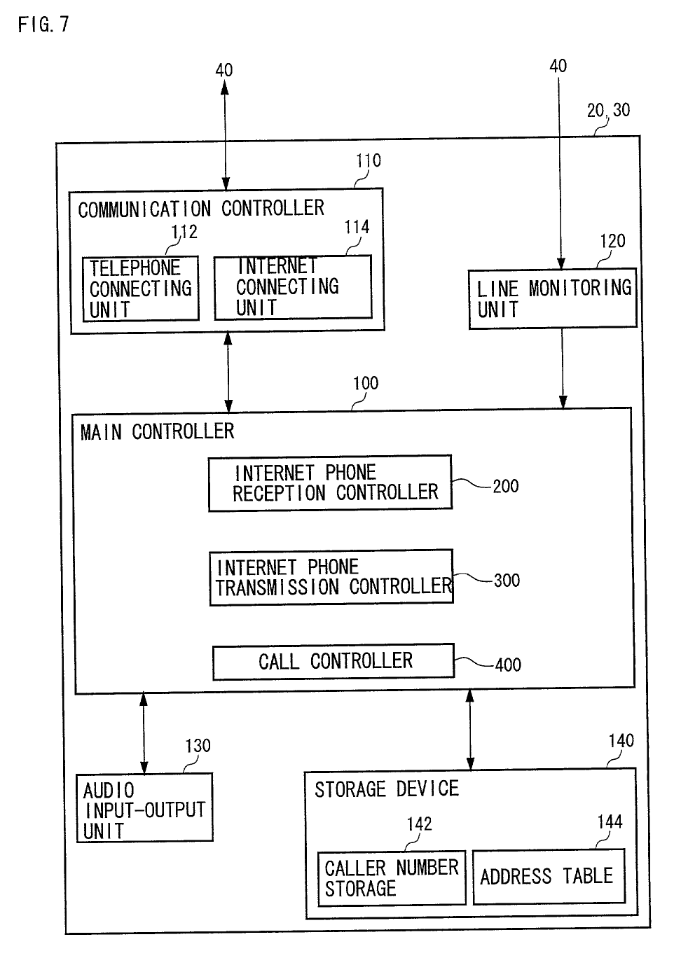

FIG. 7 shows an internal structure of a telephone device that can be used as the originator terminal 20 and the receiver terminal 30. In terms of hardware components, this structure is realized by a CPU of an arbitrary computer, a memory, a memory-loaded program capable of controlling the Internet phone, and so forth. Illustrated here, however, are the functional blocks realized by the combination of those. Therefore, it should be understood by those skilled in the art that these functional blocks can be realized in various forms by hardware alone, by software alone or by the combination thereof.

The terminals 20 and 30 include principally a main controller 100, a communication controller 110 and a storage device 140. The communication controller 110 handles the exchange of information between the main controller 100 and other devices and terminals. The communication controller 110, which includes a telephone connecting unit 112 and an Internet connecting unit 114, is equipped with hardware, such as a modem needed for communication, and a driver for controlling the communication and other programs. The telephone connecting unit 112 mainly controls communications over the telephone network 40. The Internet connecting unit 114 mainly controls communications over the Internet 60.

A line monitoring unit 120, which runs on standby power, monitors the arrival of a call from the originator terminal 20 through the telephone network 40. At the arrival of a call, the line monitoring unit 120 communicates it to an Internet phone reception controller 200 of the main controller 100.

An audio input-output unit 130 includes an audio input-output device, such as microphone and speaker, and a structure to control the device. Audio information inputted by an audio input device is transmitted to the other party's device via a call controller 400 of the main controller 100. The audio information communicated from the other party's device via the call controller 400 is outputted by an audio output device. For the exchange of image data in addition to the audio information, an image input-output unit, such as camera and liquid crystal display, may be further provided.

The storage device 140 stores various data and tables. A caller number storage 142 stores the telephone number of the originator terminal 20 notified via the line monitoring unit 120. As will be described later, this telephone number is used to specify an originating caller and to search for the mail address to which the IP address of the own device is to be notified.

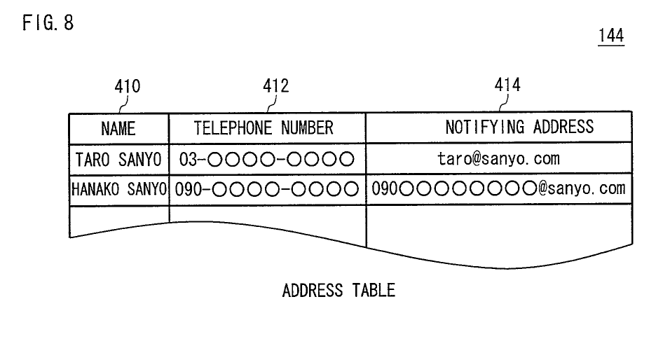

An address table 144 stores originator information and mail addresses to which the IP address assigned to the own device is to be notified, in a manner that the originator information is associated with the mail address. FIG. 8 shows an example of the structure in which a name column 410, a telephone number column 412 and a notifying mail address column 414 are provided. Recorded as an example are the telephone number “03-OOOO-OOOO and the notifying mail address “taro@sanyo.com” as information on the originating caller whose name is “Taro Sanyo”. Based on this information, the terminal 30 transmits the IP address assigned to its own device to the mail address “taro@sanyo.com” when an originator's number notified at the arrival of the call over the telephone network 40 is “03-OOOO-OOOO.”

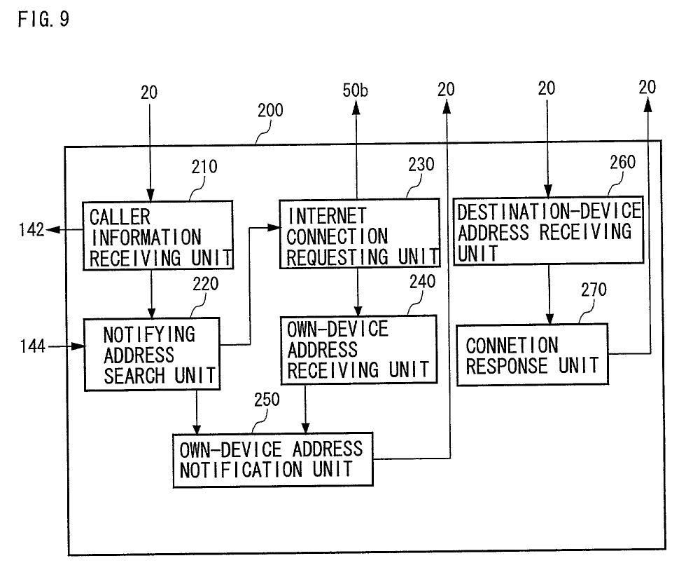

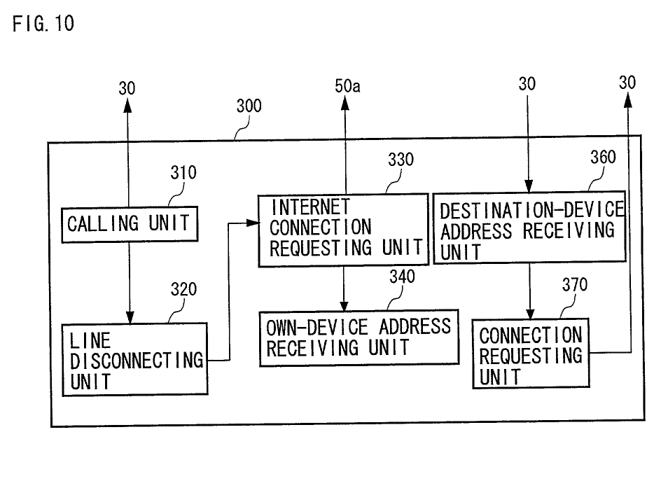

The main controller 100 includes an Internet phone reception controller 200, an Internet phone transmission controller 300 and a call controller 400. The Internet phone reception controller 200 controls a connection of the own device to the originator terminal 20 via the Internet 60. The Internet phone transmission controller 300 controls a connection of the own device to the receiver terminal 30 via the Internet 60. The Internet phone reception controller 200 and the Internet phone transmission controller 300 will be described in detail in FIG. 9 and FIG. 10, respectively.

The call controller 400 performs a control for a telephone communication with the other party's device by carrying out necessary processings to the audio information conveyed from the audio input-output unit 130 and the audio information conveyed from the other party's device via the communication controller 110. The necessary processings include, for instance, an A/D conversion processing, a D/A conversion processing, a noise reduction processing, a packet processing for communication via the Internet 60, and so forth.

FIG. 9 shows an internal structure of the Internet phone reception controller 200. The Internet phone reception controller 200 includes a caller information receiving unit 210, a notifying address search unit 220, an Internet connection requesting unit 230, an own-device address receiving unit 240, an own-device address notification unit 250, a destination-device address receiving unit 260 and a connection response unit 270.

The caller information receiving unit 210 receives the telephone number of the originator terminal 20 communicated from the line monitoring unit 120 and stores it in the caller number storage 142. Upon reception of the originator's number by the caller information receiving unit 210, the notifying address search unit 220 refers to the address table 144 and thereby acquires the mail address to which the IP address of the own device is to be notified. The mail address thus acquired is notified to the own-device address notification unit 250.

The Internet connection requesting unit 230 requests a connection to the Internet 60 by first dialing up the provider 50b in order to establish a connection to the originator terminal 20 via the Internet 60. The timing for a connection request may be immediately after the detection of the arrival of a call by the line monitoring unit 120. Thereby, the time from the arrival of the call to the establishment of the connection can be shortened. The timing for a connection request may be after the notifying address search unit 220 has referred to the address table and has confirmed that the notified caller number is stored in it. When a call is originated from a non-registered caller, a connection to the Internet may not be attempted since the IP address of the own device cannot be notified to the non-registered caller. Thereby, unnecessary communication cost can be avoided.

There may be further provided a judging unit (not shown) which judges whether to connect to the Internet 60 or not at the detection of the arrival of a call by the line monitoring unit 120. For example, when an incoming call has lasted longer than a predetermined length of time or when an originator number is not stored in the address table 144, a connection to the Internet 60 may not be made, interpreting it to be a connection request through the ordinary telephone network 40. Different incoming call tones may be used for the connection request over the telephone network 40 and the connection request over the Internet 60. To prevent a connection to the Internet 60 when a call cannot be made because of the absence of the receiving party, a structure may be such that the setting not to connect to the Internet 60 can be used in the receiving party's absence. In this structure, the absence of the called party may be notified to the originator terminal 20 via the telephone network 40.

When the Internet connection requesting unit 230 requests a connection to the provider 50b and the provider 50b permits the connection, the own-device address receiving unit 240 receives an IP address assigned from the provider 50b. The received IP address is communicated to the own-device address notification unit 250.

The own-device address notification unit 250 transmits the IP address of the own device communicated from the own-device address receiving unit 240, to the mail address communicated from the notifying address search unit 220. The IP address is informed, recorded in a predetermined position of electronic mail, such as in the first line and so forth, for example. The IP address of the own device may be informed not in the electronic mail but in a message using a communications protocol, such as TCP/IP and so forth.

The destination-device address receiving unit 260 receives a through-the-Internet(60) connection request transmitted from the originator terminal 20. At this time, the IP address of the originator terminal 20 is also notified. The IP address of the originator terminal 20 is conveyed to the connection response unit 270. The connection response unit 270 transmits a response for the establishment of a connection to the IP address of the originator terminal 20. This establishes a connection to the originator terminal 20 via the Internet 60, thus making a telephone communication possible.

FIG. 10 shows an internal structure of the Internet phone transmission controller 300. The Internet phone transmission controller 300 includes a calling unit 310, a line disconnecting unit 320, an Internet connection requesting unit 330, an own-device address receiving unit 340, a destination-device address receiving unit 360 and a connection requesting unit 370.

The calling unit 310 calls the receiver terminal 30 to establish a connection to the receiver terminal 30. At this time, the telephone number of the own device is informed. After the calling unit 310 has called the receiver terminal 30, the line disconnecting unit 320 disconnects the line. Upon the disconnection of the line by the line disconnecting unit 320, the Internet connection requesting unit 330 dials up the provider 50a to request for a connection to the Internet 60. When there is a notification to the effect that a connection cannot be made for reasons of absence and so forth, a connection to the Internet may not be attempted. This can prevent the wasting of the communication cost.

With the connection to the Internet 60 permitted by the provider 50a, the own-device address receiving unit 340 receives an IP address assigned by the provider 50a. The received IP address is communicated to the connection requesting unit 370.

The destination-device address receiving unit 360 receives information that includes the IP address of the receiver terminal transmitted from the receiver terminal 30. Where the IP address is notified by electronic mail, the IP address described in the predetermined position, for instance, in the first line, is extracted. Where it is informed by some other protocol, the IP address is extracted by a predetermined method in the protocol. The connection requesting unit 370 transmits a request for a connection via the Internet 60 to the IP address of the receiver terminal 30. At this time, the IP address of the own device communicated from the own-device address receiving unit 340 is informed to the receiver terminal 30. This enables a connection with the receiver terminal 30 via the Internet 60.

A variety of effects are derived by the telephone device and connection method according to the present embodiments. Firstly, there is an advantage in terms of communications cost since it is not necessary that the terminals 20 and 30 be always connected to the Internet 60. Also, there is an advantage in terms of installation cost and running cost because the capability of telephone communications over the Internet using ordinary phone lines precludes the necessity of installing the ISDN lines and dedicated lines. Moreover, the dial-up connection to the Internet 60 assures increased security due to the randomly given IP address when compared with the use of the fixedly assigned IP address.

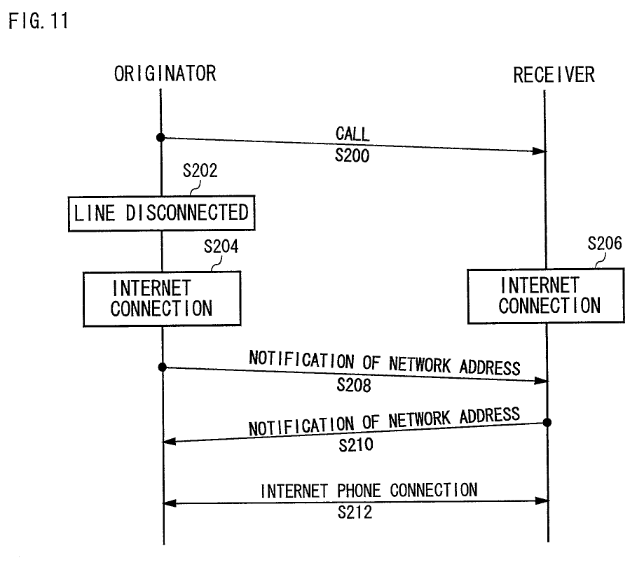

FIG. 11 shows an outline of a connection establishing method according to a second embodiment. The differences of the method according to this embodiment from the first embodiment shown in FIG. 2 lie principally in a point where the IP address is notified not from a receiver terminal 30 side but from an originator terminal 20 side. The structure of the system as a whole is similar to that of the first embodiment shown in FIG. 1, and the internal structures of the originator terminal 20 and the receiver terminal 30 are also similar to that of the first embodiment shown in FIG. 7.

In FIG. 11, the originator terminal 20 first calls the receiver terminal 30 (S200), then disconnects the line (S202), and connects to the Internet 60 (S204). At this time, the receiver terminal 30 connects to the Internet 60, using the arrival of the call from the originator terminal 20 as a trigger (S206). In the same way as the first embodiment, whether to connect to the Internet 60 or not may be judged.

When connected to the Internet 60, the originator terminal 20 notifies the receiver terminal 30 of the assigned IP address (S208). The notification method may be the use of either electronic mail or a message using the TCP/IP or the like. The receiver terminal 30 receives the IP address of the originator terminal 20, and the receiver terminal 30 sends and notifies the IP address of the own device to said IP address (S210). Thereby, the both parties could learn the IP addresses of each other, so that they now establish a connection over the Internet 60 and communicate with each other (S212).

According to this embodiment, even when a connection request is to be made to a receiver terminal 30 in which the notifying address to oneself is not registered, the connection can be established, provided that the calling party knows the notifying address of the receiver.

The present invention has been described based on several embodiments which are only exemplary. It is understood by those skilled in the art that there still exist other various modifications to the combination of each component and each processing process thereof and that such modifications are within the scope of the present invention.

In one example of such the modifications, whereas in the embodiment the IP address of the own device is notified to an electronic address which has been registered in advance, the IP address of the own device may be notified to a predetermined server connected to the Internet 60. At this time, the other party's device accesses said server via the Internet 60 and acquires the notified IP address. This can save the trouble of registering in advance the mail addresses to be notified.

Since it is expected that there is a time lag from when a call is made to the receiver terminal 30 by the originator terminal 20 till when a communication between them becomes possible, the originator terminal 20 may be further provided with an alarm or like function by which a user is notified of the establishment of a connection by the Internet phone. Thereby, the user need not keep waiting for a response from the receiver after the call was made.

Although the telephone device according to the present embodiments is capable of both transmission and reception of a connection request via the Internet, the telephone device may be one that is capable only of either one of them. For example, the telephone device capable of transmission only may be structured without the Internet phone reception controller 200. The telephone device capable of reception only may be structured without the Internet phone transmission controller 300.

According to the present embodiments, a technology for properly establishing connections through networks can be provided. Moreover, there can be provided a highly expedient telephone device using the technology.

Although the present invention has been described by way of exemplary embodiments, it should be understood that many changes and substitutions may be made by those skilled in the art without departing from the spirit and the scope of the present invention which is defined only by the appended claims.

What is claimed is:

1. A method of connecting an originator device and a receiver device via a network, including:
notifying, by the originator device via a second network which differs from said network, the receiver device of originator information which specifies the originator device;
establishing a connection to said network by the originator device and the receiver device;
acquiring, by the receiver device, a receiver address which specifies the receiver device in said network;
acquiring, by the originator device, an originator address which specifies the originator device in said network;
notifying, by the receiver device, a device specified by the originator information of the receiver address;
notifying, by the originator device, a device specified by the receiver address of the originator address, and requesting a connection via said network; and
responding to the device specified by the originator address so as to establish the connection via said network, by the receiver device.

2. A method according to claim 1, further including: acquiring, based on a correspondence relation between the originator information and an electronic mail address to which the receiver address is to be notified, said electronic mail address, wherein said notifying the receiver address is such that the receiver address is sent to said electronic mail address.

3. A method according to claim 2, wherein, when identifying the correspondence relation fails, any process thereafter is terminated.

4. A method according to claim 1, wherein said notifying the originator information is such that the originator device calls the receiver device to inform a telephone number of the originator device.

5. A method according to claim 2, wherein said notifying the originator information is such that the originator device calls the receiver device to inform a telephone number of the originator device.

6. A method according to claim 4, further including:
disconnecting the second network used for notifying the telephone number, following said notifying the originator information.

7. A method of connecting an originator device and a receiver device via a network, including: requesting, by the originator device, a through-said-network connection to the receiver device via a second network which differs from said network;
establishing connections to said network, by the originator device and the receiver device;
acquiring, by the receiver device, a receiver address which specifies the receiver device in said network;
acquiring, by the originator device, an originator address which specifies the originator device in said network;
notifying, by the originator device, the receiver device of the originator address;
notifying, by the receiver device, a device specified by the originator address of the receiver address; and
establishing a connection via said network between the originator device and the receiver device.

8. A telephone device, comprising:
a calling unit which makes a call to a telephone device of a receiver via a telephone network;
a line disconnection requesting unit which requests disconnection of a line of the telephone network after the call is made;
an Internet connection requesting unit which requests a connection to the Internet after notifying originator information;
an own-device address receiving unit which acquires an own-device address to specify own device in the Internet;
a destination-device address receiving unit which receives a receiver address sent from the telephone device of the receiver, to specify the telephone device of the receiver in the Internet; and
a connection requesting unit which notifies the own-device address to the receiver address, and requests a through-the-Internet connection.

9. A telephone device, comprising:
a line monitoring unit which monitors a connection request notified from a telephone device of an originator via a telephone network;
an originator information receiving unit which receives originator information, notified together with the connection request, to specify the telephone device of the originator;
an Internet connection requesting unit which requests a connection to the Internet when the connection request is received;
an own-device address receiving unit which acquires an own-device address to specify an own device in the Internet;
an address table which stores the originator information and mail addresses to which the own-device address is to be notified, in a manner that the originator information is associated with the mail address;
a notifying address search unit which acquires the mail address to be notified, by referring to said address table;
an own-device address notification unit which transmits the own-device address to the mail address to be notified;
a destination-device address receiving unit which receives a destination-device address, which was transmitted to the own-device address from the telephone device of the originator, to specify the telephone device of the originator in the Internet; and
a connection response unit which, upon receipt of a request of a through-the-Internet connection, transmits a response to establish the connection.

10. A device according to claim 9, further comprising:
a calling unit which makes a call to a telephone device of a receiver via a telephone network;
a line disconnection requesting unit which requests disconnection of a line of the telephone network after the call is made;
a second Internet connection requesting unit which requests a connection to the Internet after notifying originator information;
a second own-device address receiving unit which acquires an own-device address to specify an own device in the Internet;
a second destination-device address receiving unit which receives a receiver address sent from the telephone device of the receiver, to specify the telephone device of the receiver in the Internet; and
a connection requesting unit which notifies the own-device address to the receiver address, and requests the through-the-Internet connection.

11. A method of connecting an originator device and a receiver device via a network, the method being performed in said originator device and including:
notifying the receiver device of originator information to specify the originator device, via a second network which differs from said network;
establishing a connection to said network;
acquiring an originator address in said network;
receiving a receiver address in said network sent from said receiver device utilizing the originator information; and
notifying a device specified by the receiver address, of the originator address and requesting a through-said-network connection.

12. A method according to claim 11, further including:
disconnecting a line of the second network used to notify a telephone number, after said notifying the originator address.

13. A method of connecting an originator device and a receiver device via a network, the method being performed in said receiver device and including:
receiving originator information to specify the originator device, from the originator device via a second network which differs from said network;
establishing a connection to said network;
acquiring a receiver address in said network;
notifying the originator device of the receiver address; and
responding to establish a through-said-network connection to a device specified by an originator address in said network when a connection is requested from the originator device via said network.

14. A method according to claim 13, wherein said notifying the receiver address is carried out by electronic mail.

15. A method according to claim 14, wherein, identifying electronic mail address of the originator device fails, any process thereafter is terminated.
